(19) United States
(12) Patent Application Publication
(10) Pub. No.: US 2009/0061889 A1
(43) Pub. Date: Mar. 5, 2009

(54) METHOD AND DEVICE FOR FREQUENCY ALLOCATION MANAGEMENT IN AN AD HOC NETWORK

(75) Inventors: Ramy S. Ayoub, Arlington Heights, IL (US); Michael S. Johnson, Orlando, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/847,502

(22) Filed: Aug. 30, 2007

(51) Int. Cl. H04Q 7/20

(52) U.S. Cl. 455/452.1

(57) ABSTRACT

Disclosed is a method for frequency allocation management in an ad hoc network that includes a plurality of cognitive radio devices. The method comprises dynamically selecting a cognitive radio device from the plurality of cognitive radio devices based on a communication device criteria, assigning a role of a central resource manager to the selected cognitive radio device to assume responsibility of allocating frequency to other of the cognitive radio devices within the ad hoc network, selecting a backup cognitive radio device from other one of the cognitive radio devices within the ad hoc network by the central resource manager, and transferring the role of the central resource manager to the backup cognitive radio based on a second criteria by the central resource manager.

### FIELD OF THE DISCLOSURE

The present disclosure relates generally to ad hoc networks, and more specifically to frequency allocation in ad hoc networks.

### BACKGROUND

Wireless communications industry has grown significantly over recent years, and the demand of wireless communications continues to rise in terms of the technologies available, the services on offer, and the number of users who can be supported. Broadband services are further stretching the limits of spectrum. However, spectrum is a finite resource and as such must be managed effectively across all technologies and every region of the world. Therefore, spectrum management is vital to the long-term growth of the wireless communications industry.

In the past, cognitive radio technology has been proposed and has attracted researchers' attention all over the world. Cognitive radio technology utilizes radio transceivers that can adaptively select the communication methods, modulation methods, frequency, and the like, according to the recognized surrounding radio environment. In a conventional frequency assignment policy, the frequency band is fixedly assigned to an operator. Cognitive radio technology has changed such conventional frequency assignment policies. In cognitive radio technology, the frequency band that is not used by the other communication systems can be used for any users, so the fixed frequency assignment may not be required.

Federal Communications Commission (FCC), a United States Government Agency has issued a notice of proposed rulemaking (NPRM) encouraging cognitive radio technology as a candidate to implement negotiated or opportunistic spectrum sharing. Since current wide area networks such as cellular networks cannot meet the projected demands of the spectrum availability, there is a need to create alternative wide area networks which can provide unlimited spectrum availability. In wireless networks such as ad hoc networks, frequency allocation is an important design aspect and a significant problem in the utilization of ad hoc networks is the rapid and accurate detection and assignment of unused spectrum.

Ad hoc networks are characterized by dynamic topologies, with nodes constantly entering and leaving the network. Ad hoc networks are self organizing and self healing, meaning that they are capable of sustaining the change in network node involvement. However, the speed and accuracy with which the ad hoc networks can detect vacated and occupied spectrum will be a large factor in determining the overall throughput and effectiveness of the system in routing data traffic.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication network employing a method in accordance with some embodiments of the present invention.

FIG. 2 is a block diagram illustrating an example of a cognitive radio device employed in the network shown in FIG. 1 in accordance with some embodiments of the present invention.

FIG. 3 is a flowchart showing an example of operations performed by a cognitive radio device in the network shown in FIG. 1 to assign a role of a central resource manager in accordance with some embodiments of the present invention.

FIG. 4 is a flowchart showing an example of operations performed by the central resource manager to perform the frequency allocation to other cognitive radio devices within the network in accordance with some embodiments of the present invention.

FIG. 5 is a flowchart illustrating an example of operations performed by the central resource manager to transfer the role of the central resource manager to a backup device in accordance with some embodiments of the present invention.

FIG. 6 is a block diagram of the ad hoc network of FIG. 1 including a central resource manager and a backup device among the plurality of cognitive radio devices in accordance with some embodiments of the present invention.

FIG. 7 is a block diagram of the ad hoc network illustrating a scenario of a backup device assuming the responsibility of the central resource manager when the central resource manager departs from the network in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail embodiments that are in accordance with the present invention, it should be observed that the embodiments reside primarily in combinations of method steps and device components related to frequency allocation management in an ad hoc network. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one module or action from another module or action without necessarily requiring or implying any actual such relationship or order between such modules or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for frequency allocation management. The non-processor circuits may include, but are not limited to, a radio receiver, a radio transmitter, signal drivers, clock circuits, power source circuits, and user input devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustrative provided to enable persons skilled in the art to make or use the invention and not to limit the scope of the invention which is defined by the claims.

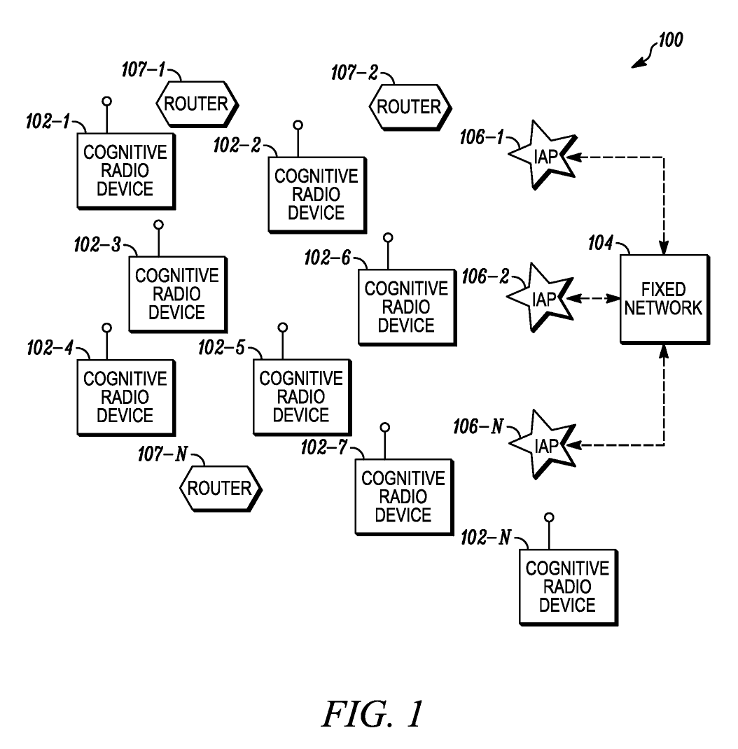

FIG. 1 is a block diagram illustrating an example communication network employing a method in accordance with some embodiments of the present invention. Specifically, FIG. 1 illustrates an ad hoc network 100. The ad hoc network 100 may comprise of cognitive as well as non-cognitive ad hoc capable networks. As used herein, the term “ad hoc network” refers to a self-configuring network of cognitive as well as non-cognitive radio devices connected by wireless links, the union of which forms an arbitrary topology. The ad hoc network 100, for example, can be a mesh enabled architecture (MEA) network or an 802.11 network (i.e. 802.11a, 802.11b, 802.11g, or 802.11s). It will be appreciated by those of ordinary skill in the art that the ad hoc network 100 in accordance with the present invention can alternatively comprise any packetized communication network where packets are forwarded across multiple wireless hops. For example, the ad hoc network 100 can be a network utilizing packet data protocols such as OFDMA (orthogonal frequency division multiple access), TDMA (time division multiple access), GPRS (General Packet Radio Service) and EGPRS (Enhanced GPRS). Additionally, each wireless hop of the ad hoc network 100 may either employ the same packet data protocol as the other hops, or a unique packet data protocol per hop.

As illustrated in FIG. 1, the ad hoc network 100 includes a plurality of cognitive radio devices 102-1 through 102-n (referred to also as devices 102 or nodes 102 or mobile nodes 102 or communication devices 102) as well as non-cognitive radio devices (not shown), and can, but is not required to, include a fixed network 104 having a plurality of intelligent access points (IAP) 106-1, 106-2, . . . 106-n (referred to generally as nodes 106 or access points 106), for providing cognitive radio devices 102 with access to the fixed network 104. The fixed network 104 can include, for example, a core local access network (LAN), and a plurality of servers and gateway routers to provide network nodes with access to other networks, such as other ad hoc networks, a public switched telephone network (PSTN) and the Internet. The ad hoc network 100 further can include a plurality of fixed or mobile routers 107-1 through 107-n (referred to generally as routers 107 or nodes 107 or communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly, or via one or more other nodes 102, 106 or 107 operating as a router or routers for packets being sent between nodes. It can also be appreciated that nodes 102 can take on the role of routers in ad hoc networks.

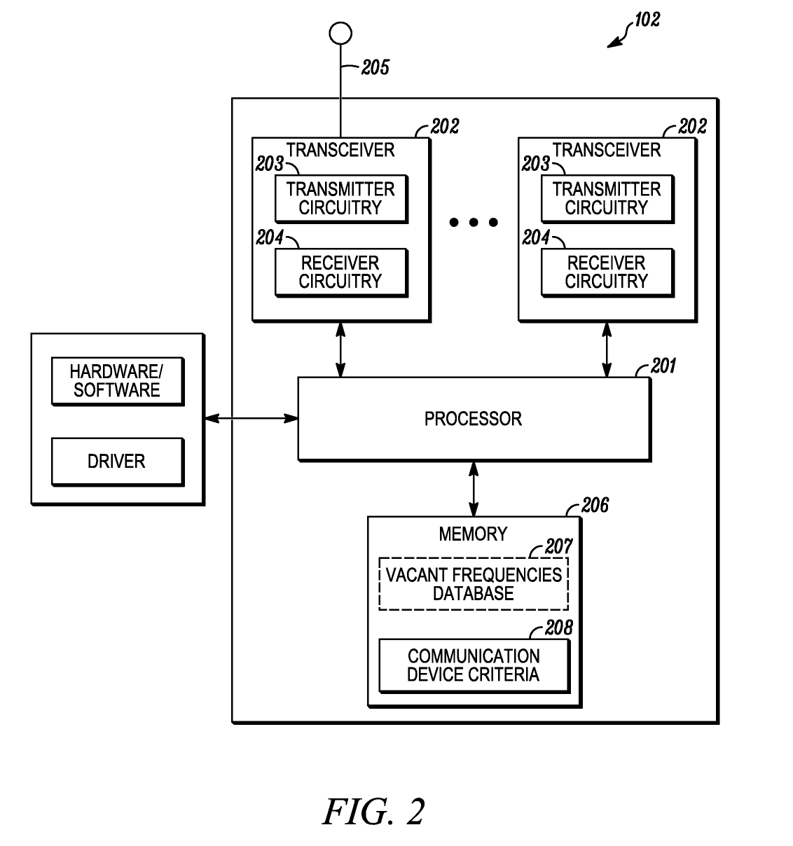

FIG. 2 is a block diagram of an example of a cognitive radio device 102 for operation within the ad hoc network 100 of FIG. 1. The cognitive radio device 102 comprises a processor 201, one or more transceivers 202, each including a transmitter circuitry 203 and a receiver circuitry 204, an antenna 205 coupled to at least one of the transceivers 202, and a memory 206 for storing operating instructions that are executed by the processor 201. The transceiver 202 receives and transmits signals, such as packetized signals, to and from other cognitive radio devices 102, under the control of a processor 201. The cognitive radio device 102 optionally includes a display, an input device, a buffer memory, and communication interfaces. Although not shown, the cognitive radio device 102 also includes an antenna switch, duplexer, circulator, or other highly isolative means (not shown) for intermittently providing information packets from the transmitter circuitry 203 of the transceiver 202 to the antenna 205 and from the antenna 205 to the receiver circuitry 204 of the transceiver 202. The device 102 can be an integrated unit containing at least all the elements depicted in FIG. 2, as well as any other elements necessary for the cognitive radio device 102 to perform its particular functions. Alternatively, the cognitive radio device 102 can comprise a collection of appropriately interconnected units, wherein such units perform functions that are equivalent to the functions performed by the elements of the device 102. For example, the cognitive radio device 102 may comprise a laptop computer and a wireless LAN (local area network) card.

The processor 201 includes one or more microprocessors, microcontrollers, DSPs (digital signal processors), state machines, logic circuitry, or any other device or devices that process information based on operational or programming instructions. Such operational or programming instructions are, for example, stored in the memory 206. The memory 206 may be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card or any other medium for storing digital information. One of ordinary skill in the art will recognize that when the processor 201 has one or more of its functions performed by a state machine or logic circuitry, the memory 206 containing the corresponding operational instructions may be embedded within the state machine or logic circuitry. The operations performed by the processor 201 and the rest of the device 102 are described in detail below.

The transmitter circuitry 203 and the receiver circuitry 204 enable the device 102 to communicate information packets to and acquire information packets from the other devices 102. In this regard, the transmitter circuitry 203 and the receiver circuitry 204 include conventional circuitry to enable digital or analog transmissions over a wireless communication channel. The transmitter circuitry 203 and the receiver circuitry 204 are designed to operate over both a cellular air interface (e.g., Global System for Mobile communication (GSM), Code Division Multiple Access (CDMA), Wide-band CDMA (WCDMA), Universal Mobile Telecommunications System (UMTS), and the like) and an ad hoc networking air interface (e.g., BLUETOOTH, 802.11 WLAN (wireless local area network), 802.16 WiMax, and the like).

The implementations of the transmitter circuitry 203 and the receiver circuitry 204 depend on the implementation of the device 102. For example, the transmitter circuitry 203 and the receiver circuitry 204 can be implemented as an appropriate wireless modem, or as conventional transmitting and receiving components of two-way wireless communication devices. In the event that the transmitter circuitry 203 and the receiver circuitry 204 are implemented as a wireless modem, the modem can be internal to the cognitive radio device 102 or insertable into the cognitive radio device 102 (e.g., embodied in a wireless radio frequency (RF) modem implemented on a Personal Computer Memory Card International Association (PCMCIA) card). For a wireless communication device, the transmitter circuitry 203 and the receiver circuitry 204 can be implemented as part of the wireless device hardware and software architecture in accordance with known techniques. Most, if not all, of the functions of the transmitter circuitry 203 and/or the receiver circuitry 204 can be implemented in a processor, such as the processor 201. However, the processor 201, the transmitter circuitry 203, and the receiver circuitry 204 have been artificially partitioned herein to facilitate a better understanding.

The receiver circuitry 204 is designed to allow receiving of RF signals from within at least one bandwidth and optionally more bandwidths, if the communications with the proximate device are in a frequency band other than that of the network communications. The receiver circuitry 204 may optionally comprise a first receiver and a second receiver, or one receiver designed to allow receiving within two or more bandwidths. The transceiver 202 includes at least one set of transmitter circuitry 203. The at least one transmitter 203 may be designed to allow transmitting to multiple devices on multiple frequency bands. As with the receiver circuitry 204, dual transmitters 203 may optionally be employed where one transmitter is for the transmission to a proximate device or direct link establishment to WLAN's and the other transmitter is for transmission to a cellular base station.

The antenna 205 comprises any known or developed structure for radiating and receiving electromagnetic energy in the frequency range containing the wireless carrier frequencies.

The memory 206 includes communication device criteria 208. In one embodiment, the communication device criteria 208 of the cognitive radio device 102 are based on a desired resource capability to perform functions of the central resource manager. The desired resource capability of the cognitive radio device 102 may be based at least on number of transceivers 202 on the cognitive radio device 102, or an amount of memory on the cognitive radio device 102, or an amount of network traffic being serviced by the cognitive radio device 102, or a time period at which the cognitive radio device 102 entered the network 100. The communication device criteria 208 enables dynamic selection of a particular cognitive radio device from the plurality of cognitive radio devices 102-1 through 102-n to assign a role of a central resource manager to the selected cognitive radio device. As used herein, the term “central resource manager” refers to one of the cognitive radio devices 102 within the network 100 that has been selected to perform frequency allocation management within the network 100. Frequency allocation management includes, but not limited to, monitoring spectrum usage by the devices 102 within the ad hoc network 100, and allocating available spectrum to devices entering the network 100.

The device 102, when assigned the role of the central resource manager, maintains a database 207 (shown as vacant frequencies database 207) including a list vacant frequencies determined based on the frequency utilization of cognitive radio devices 102 within the ad hoc network 100. The list of vacant frequencies can be stored as a table entry in the database 207.

The processor 201 can coordinate with other components of the cognitive radio device 102 to assign a role of the central resource manager to the cognitive radio device 102 when the cognitive radio device 102 has a desired resource capability to perform frequency allocation management in the ad hoc network 100.

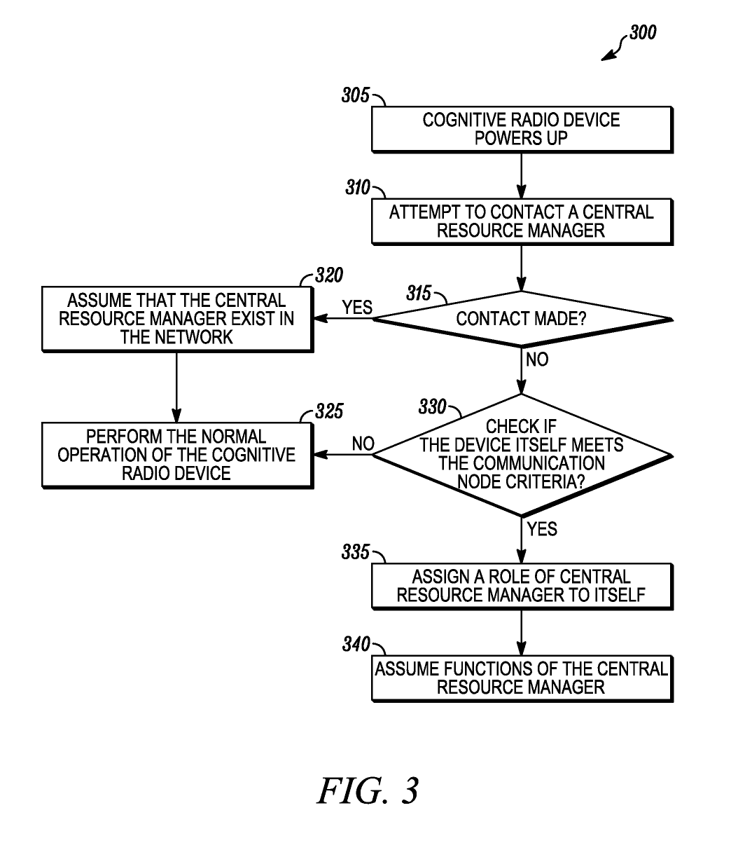

Referring to FIG. 3, a flowchart is shown illustrating an example of operations performed by a cognitive radio device 102 in the network 100 of FIG. 1 to assign a role of a central resource manager. The process 300 begins at step 305 when the cognitive radio device 102 powers up in the ad hoc network 100. At step 310, the cognitive radio device 102 attempts to contact a central resource manager within the ad hoc manager. In one embodiment, this contact may be attempted via a predefined frequency or channel. In yet another embodiment this contact may be attempted by polling a frequency range for contact with the central resource manager. At step 315, the cognitive radio device 102 checks whether a contact with the central resource manager is made. When the contact is made with the central resource manager, then at step 320, the cognitive radio device 102 assumes that the central resource manager already exists in the ad hoc network 100 and proceeds to step 325 to resume its normal operation.

Returning to the operation of step 315, when the cognitive radio device 102 is not able to establish contact with the central resource manager, then the cognitive radio device 102 assumes that the network 100 does not have a central resource manager and proceeds to step 330 and checks whether the cognitive radio device 102 itself meets the communication device criteria 208 stored in the memory 206.

Returning to the operation of step 330, when the cognitive radio device 102 meets the communication device criteria 208, then at step 335, the device assigns the role of central resource manager to itself and communicates to other devices within the network. In one embodiment, an earliest device of the cognitive radio devices 102 entering the ad hoc network 100 with the desired resource capability to perform functions of the central resource manager assigns itself the role of the central resource manager.

At step 340, the cognitive radio device 102 assumes the functions of central resource manager to perform frequency allocation management within the network. Returning to step 330, when the cognitive radio device 102 does not meet the communication device criteria 208, the cognitive radio device proceeds to step 325 and resumes the normal operation.

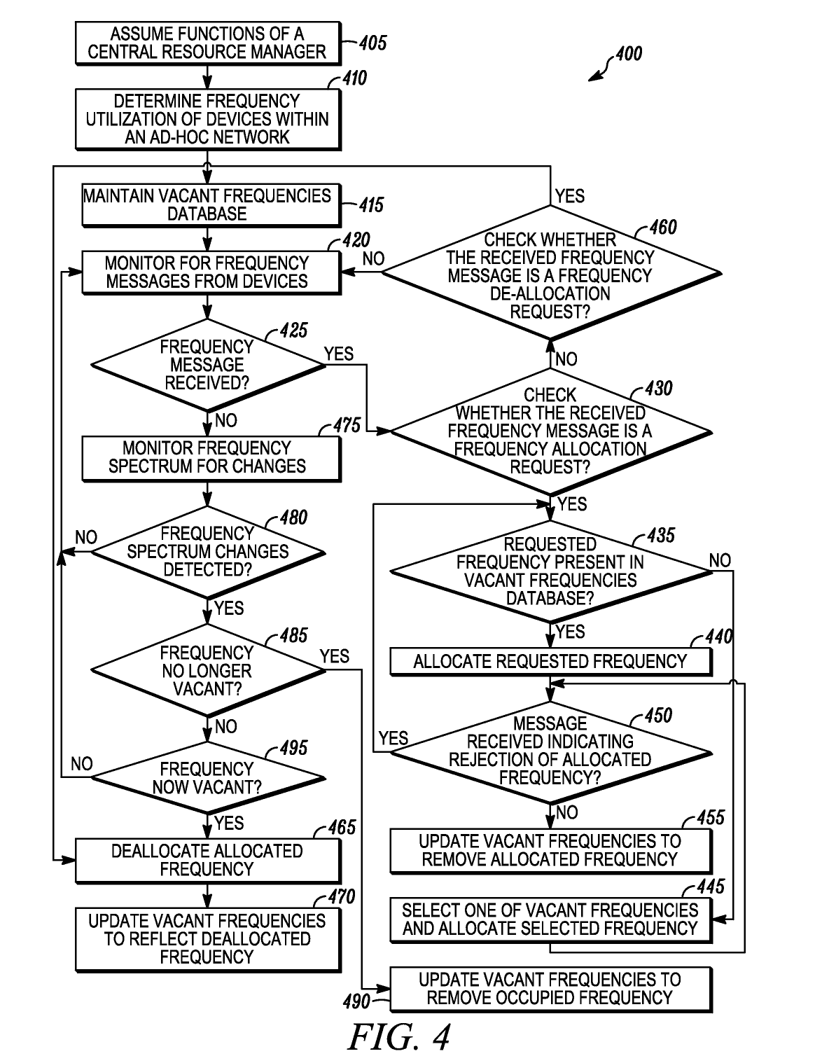

FIG. 4 is a flowchart showing an example of operations performed by the centralized resource manager for frequency allocation management within the ad hoc network 100. The process 400 begins at step 405, when one of the cognitive radio devices 102 within the network 100 has been dynamically selected as a central resource manager to assume functions of the central resource manager. At step 410, the central resource manager determines frequency utilization (spectrum usage) of all the cognitive radio devices 102 within the network 100. In one embodiment, the central resource manager queries each of the cognitive radio devices 102 within the network 100 for utilized frequencies, for example, using a fixed channel such as an assignment channel. In response to the query, each of the cognitive radio devices 102 may communicate its respective utilized frequency, power and location of the devices 102. In another embodiment, the central resource manager determines the frequency utilization by searching or monitoring the available spectrum for activity. At step 415, the central resource manager maintains a list of vacant frequencies, for example as a table entry in the vacant frequencies database 207 based on the determined frequency utilization. The central resource manager can periodically determine the frequency utilization of cognitive radio devices 102 within the network 100 and update the vacant frequencies in the database 207 on a regular basis.

At step 420, the central resource manager monitors for frequency requests from other cognitive radio devices 102 and non-cognitive radio devices within the network 100. A fixed channel such as the assignment channel or a locatable channel can be used for communications between the central resource manager and other cognitive radio devices 102 of the network 100. In one embodiment, the assignment channel may be a fixed frequency in the network 100 that has a low to zero probability of interference within other frequencies within the network 100. As the assignment channel may vary from network to network, the assignment channel may be characterized by known assignment channel packets transmitted from the central resource manager. The cognitive radio device 102 entering and leaving the network 100 may then use this assignment channel to request, or release frequencies.

At step 425, the central resource manager determines whether a frequency message is received from a first device of the devices 102 of the ad hoc network 100 and if a frequency message is received, then the central resource manager proceeds to step 430. At step 430, the central resource manager checks whether the received frequency message is a frequency allocation request. If the received frequency is a frequency allocation request, then the central resource manager proceeds to step 435 and checks whether the requested frequency is available in the vacant frequencies database. At step 440, the central resource manager allocates the requested frequency to the first device when the requested frequency is available in the vacant frequencies database.

Returning to step 435, when the requested frequency is not available in the vacant frequencies database, the central resource manager selects one of available frequencies from the vacant frequencies database and allocates the selected frequency as shown in step 445. In response to the allocation of the selected frequency, the first device may either accept the allocated frequency or request for a different frequency. The first device may then send a message indicating rejection of the allocated frequency and/or requesting a new frequency. At step 450, the central resource manager determines whether it has received a message indicating rejection of allocated frequency from the first device. When the central resource manager receives the message indicating rejection of allocated frequency from the first device, then the central resource manager proceeds to step 435 and checks whether the requested frequency is present in vacant frequencies database 207. Returning to step 450, when the central resource manger does not receive any message from the first device, the central resource manager assumes that the first device has accepted the allocated frequency and proceeds to step 455 to update the vacant frequencies database to remove the allocated frequency from the list of vacant frequencies maintained in the vacant frequencies database 207.

Returning to operation of step 430, if the received frequency message is not a frequency allocation request, the central resource manager proceeds to step 460 and checks whether the received frequency message is a frequency de-allocation request. In one embodiment, the cognitive radio devices 102 or non-cognitive radio devices may send the frequency de-allocation request to the central resource manager when the cognitive radio devices 102 or non-cognitive radio devices depart from the network 100. In another embodiment, the cognitive radio device 102 may be moving within the network and therefore may send a frequency de-allocation request to the central resource manager in order to request for a new frequency from the central resource manager. At step 460, when the central resource manager receives the frequency de-allocation request from one of the devices of the network 100, the central resource manager proceeds to step 465 and deallocates the allocated frequency from the device 102 which has requested frequency de-allocation. Then, at step 470, the central resource manager updates the list of vacant frequencies maintained in the vacant frequencies database 207 to reflect the de-allocated frequency.

Returning to operation of step 425, when the central resource manager does not receive a frequency message, the central resource manager proceeds to step 475. In step 475, the central resource manager monitors the frequency spectrum for changes that may occur during the sudden departure of cognitive or non-cognitive radio devices, or the sudden arrival of non-cognitive radio devices. If no frequency change is detected in step 480, then the central resource manger continues to monitor for frequency messages as shown in step 420. At step 480, if a frequency change is detected, then the central resource manager proceeds to step 485 and determines whether the frequency is no longer vacant. If the frequency has been occupied by a non-cognitive radio or another device, then the vacant frequency table will be updated to reflect the occupancy of that frequency as shown in step 490. At step 495, if the frequency is now vacant, for example, due to the abrupt departure of a cognitive or non-cognitive radio devices, then the central resource manager proceeds to step 465 where the central resource manager deallocates the allocated frequencies and updates the list of vacant frequencies in the vacant frequencies database to reflect the de-allocated frequencies as shown in step 470. Returning to step 495, when the central resource manager detects that the frequency is not vacant, the operation of the central resource manager returns to step 420, where the central resource manger continues to monitor for frequency messages from devices 102 of the network 100.

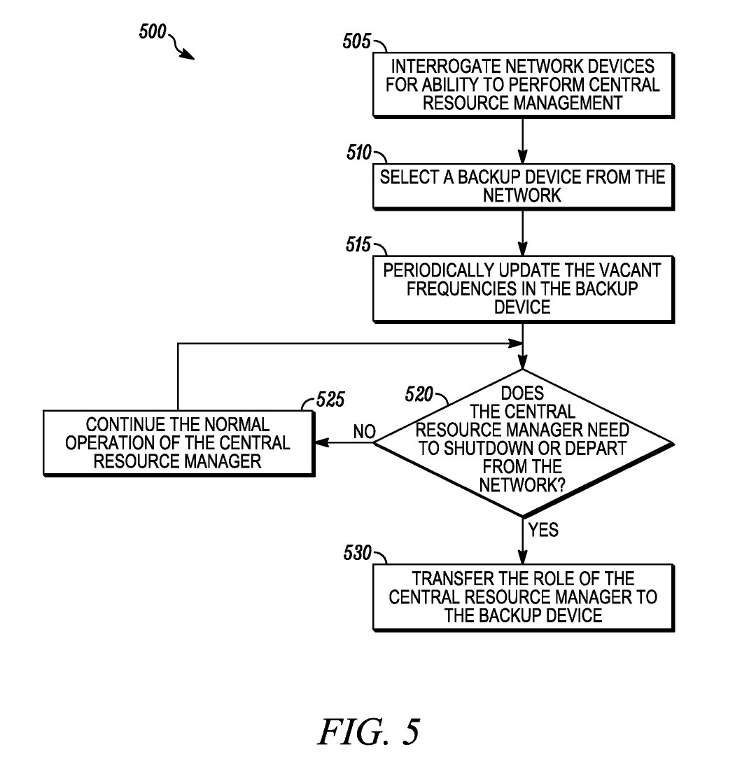

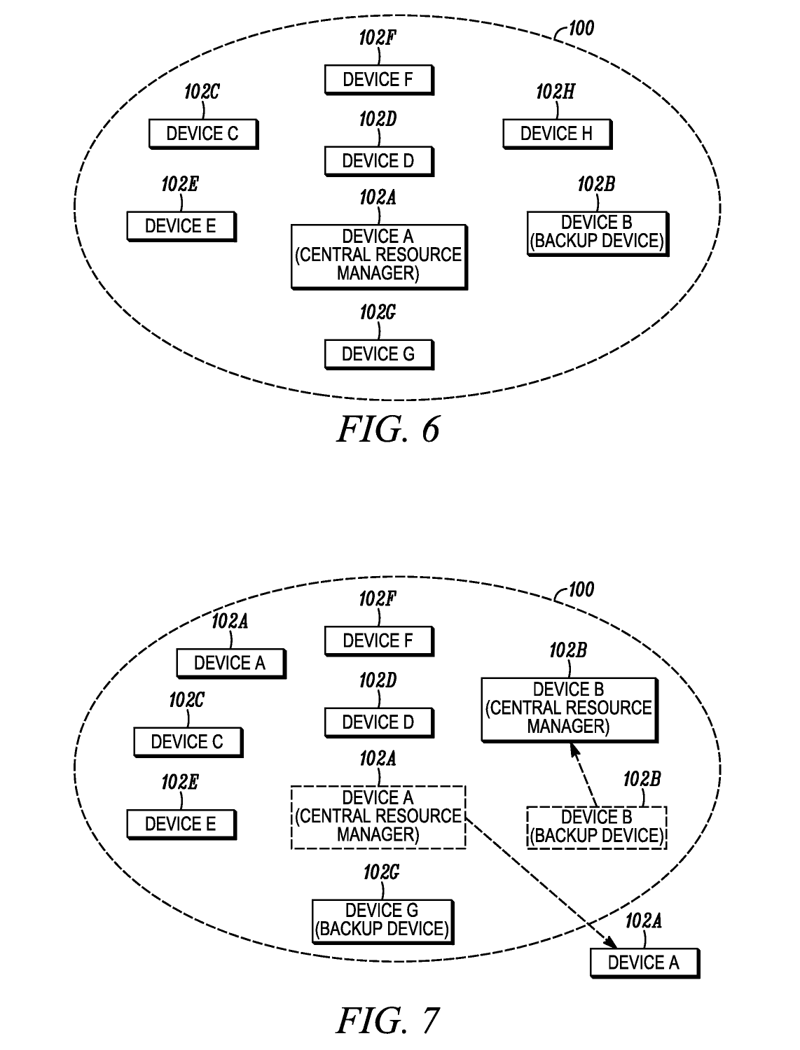

FIG. 5 illustrates an example of operations performed by the central frequency manager to transfer the role of the central frequency manager to a backup device is described. FIG. 6 illustrates an ad hoc network 100 of FIG. 1 including a central resource manager and a backup device among the plurality of cognitive radio devices. FIG. 7 illustrates a scenario of the backup device assuming the responsibility of the central resource manager when the central resource manager departs from the network

Referring to FIG. 5, the process 500 begins at step 505, in which the central resource manager, for example, device 102A (see FIG. 6) interrogates other devices 102B-H within the network 100 for their ability to perform frequency allocation management in the network 100. In response to the query, each of the devices 102B-H within the network 100 may communicate their respective information related to the resource capability. The information related to the resource capability of the devices 102B-H may include, but is not limited to, a number of transceivers on the device, an amount of memory on the devices 102B-H, an amount of network traffic being serviced by the devices 102B-H, a time period at which the devices 102B-H entered the network 100.

At step 510, the central resource manager (i.e. device 102A) selects a backup device, for example device 102B (see FIG. 6) having a highest resource capability among the devices 102B-H. Then, at step 515, the central resource manager communicates the list of the vacant frequencies maintained in vacant frequencies database 207 to the backup device 102B. The central resource manager can periodically communicate the updated list of vacant frequencies to the backup device 102B. At step 520, the central resource manager determines whether the device 102A needs to shutdown or depart from the network 100. When the central resource manager determines that the device 102A is not shutting down or departing from the network 100, the central resource manager continues its normal operation as shown in step 525. Returning to step 520, when the central resource manager determines that the device 102A needs to shutdown or depart from the network 100, the central resource manager proceeds to step 530. At step 530, the device 102A transfers the role of the central resource manager to the backup device 102B (see FIG. 7). After the role of the central resource manager is transferred to the backup device 102B, the backup device 102B resumes the functions of central resource manager and performs frequency allocation management of the ad hoc network 100. Further the device 102B which has been assigned as the central resource manager now interrogates other devices 102C-G within the network 100 for their ability to perform frequency allocation management in the network 100 and selects one of the devices 102C-G, for example device 102G as the backup device as shown in FIG. 7.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for frequency allocation management in an ad hoc network comprising a plurality of cognitive radio devices, the method comprising:
dynamically selecting a cognitive radio device from the plurality of cognitive radio devices based on a communication device criteria; and
assigning a role of a central resource manager to the selected cognitive radio device to assume responsibility of allocating frequency to other cognitive radio devices within the ad hoc network.

2. The method of claim 1, wherein dynamically selecting the cognitive radio device from the plurality of cognitive radio devices based on the communication device criteria comprises ensuring that the selected cognitive radio device has a desired resource capability to perform functions of the central resource manager.

3. The method of claim 2, wherein ensuring that the selected cognitive radio device has the desired resource capability comprises determining at least one of number of transceivers on the cognitive radio device, or an amount of memory on the cognitive radio device, or an amount of network traffic being serviced by the cognitive radio device.

4. The method of claim 2 wherein an earliest device entering the ad hoc network with the desired resource capability to perform functions of the central resource manager assigns itself the role of the central resource manager.

5. The method of claim 1, further comprising
determining frequency utilization of cognitive radio devices within the ad hoc network by the central resource manager;
maintaining a database including vacant frequencies based on the determined frequency utilization by the central resource manager;
receiving a frequency allocation request from a first cognitive radio device moving within the ad hoc network by the central resource manager;
allocating a frequency to the first cognitive radio device from the vacant frequencies in response to the received frequency allocation request by the central resource manager; and
updating the database to remove the allocated frequency from the vacant frequencies.

6. The method of claim 5, further comprising
detecting frequency occupancy by non-cognitive radio devices; and
updating the database to remove the occupied frequencies from the vacant frequencies.

7. The method of claim 5, further comprising:
receiving a frequency de-allocation request from the first cognitive radio device departing from the ad hoc network by the central resource manager;
de-allocating the frequency from the first cognitive radio device in response to the received frequency de-allocation request by the central resource manager; and
updating the database including the vacant frequencies to reflect the de-allocated frequency.

8. The method of claim 5 further comprising
detecting vacated frequencies by non-cognitive radio devices or cognitive radio devices that have abruptly departed the network; and
updating the database including the vacant frequencies to reflect the vacated frequencies.

9. The method of claim 1, further comprising selecting a backup cognitive radio device from other one of the cognitive radio devices within the ad hoc network by the central resource manager.

10. The method of claim 9, further comprising transferring the role of the central resource manager to the backup cognitive radio device by the central resource manager when the central resource manager departs from the ad hoc network.

11. The method of claim 9, further comprising transferring the role of the central resource manager to the backup cognitive radio device when a time period since assigning the role of the central resource manager equals a predefined time period.

12. A cognitive radio device for frequency allocation management in an ad hoc network, comprising:
at least one transceiver for communicating with other cognitive radio devices within the ad hoc network;
a processor for determining resource capability of the cognitive radio device to dynamically select the cognitive radio device to assign a role of a central resource manager based on the determined resource capability;
a memory for maintaining a database including vacant frequencies in the ad hoc network,
wherein the processor assigns the role of the central resource manager to the cognitive radio device when the cognitive radio device has a desired resource capability to perform frequency allocation management in the ad hoc network.

13. The cognitive radio device of claim 12, wherein the resource capability is based on at least one of number of transceivers on the cognitive radio device, or an amount of memory on the cognitive radio device, or an amount of network traffic being serviced by the cognitive radio device.

14. The cognitive radio device of claim 12, wherein the processor determines frequency utilization of other cognitive radio devices within the ad hoc network when the processor assigns the cognitive radio device, the role of the central resource manager.

15. The cognitive radio device of claim 14, wherein the at least one transceiver receives a frequency allocation request from a first cognitive radio device moving within the ad hoc network.

16. The cognitive radio device of claim 15, wherein the processor processes the frequency allocation request, allocates a frequency to the first cognitive radio device from the database including the vacant frequencies, and updates the database to remove the allocated frequency from the vacant frequencies.

17. The cognitive radio device of claim 16, wherein the at least one transceiver receives a frequency de-allocation request from the first cognitive radio device departing from the ad hoc network.

18. The cognitive radio device of claim 17, wherein the processor processes the de-allocation request, deallocates the frequency from the first cognitive radio device, and updates the database including the vacant frequencies to reflect the de-allocated frequency.

19. The cognitive radio device of claim 14, wherein the processor selects a backup cognitive radio device from other one of the cognitive radio devices within the ad hoc network.

20. The cognitive radio device of claim 19, wherein the processor transfers the role of the central resource manager to the backup cognitive radio device when the central resource manager departs from the ad hoc network.

21. A method for frequency allocation management in an ad hoc network comprising a plurality of cognitive radio devices, the method comprising:
dynamically selecting a cognitive radio device from the plurality of cognitive radio devices based on a communication device criteria;
assigning a role of a central resource manager to the selected cognitive radio device to assume responsibility of allocating frequency to other of the cognitive radio devices within the ad hoc network;
selecting a backup cognitive radio device from other one of the cognitive radio devices within the ad hoc network by the central resource manager; and
transferring the role of the central resource manager to the backup cognitive radio device by the central resource manager.

22. The method of claim 21, further comprising
determining frequency utilization of cognitive radio devices within the ad hoc network by the central resource manager;
maintaining a database including vacant frequencies based on the determined frequency utilization by the central resource manager;
receiving a frequency allocation request from a first cognitive radio device moving within the ad hoc network by the central resource manager;
allocating a frequency to the first cognitive radio device from the vacant frequencies in response to the received frequency allocation request by the central resource manager; and
updating the database to remove the allocated frequency from the vacant frequencies.
